(19) United States
(12) Patent Application Publication
(10) Pub. No.: US 2010/0228790 A1
(43) Pub. Date: Sep. 9, 2010

(54) METHOD FOR ACTIVATING FUNCTIONALITIES PROPOSED IN A COMPUTER TERMINAL

(75) Inventor: Francois Colon, Marseille (FR)

Correspondence Address: HARNESS, DICKEY & PIERCE, P.L.C., P.O. BOX 828, BLOOMFIELD HILLS, MI, 48303, US

(73) Assignee: Miyowa, Marseille (FR)

(21) Appl. No.: 12/396,717

(22) Filed: Mar. 3, 2009

(51) Int. Cl. G06F 15/16; G06F 17/30

(52) U.S. Cl. 707/803; 709/206; 707/E17.009

(57) ABSTRACT

The invention relates to a method for activating functionalities provided in a computer terminal and delivered by sources servers, with one of these functionalities being an instant messaging service in which a list including “user” contacts is displayed on the screen of said terminal. In this method, an instant messaging server delivering the instant messaging service emits the list of the “user” contacts, a list of the “user” contacts passes through a gateway server remote from the computer terminal, the gateway server adds on the fly “functionality” contacts into the list of the “user” contacts, the gateway server transmits to the computer terminal an aggregated list including the “user” contact and the “functionality” contacts the computer terminal displayed on the screen the aggregated list in which the “user” contacts and the “functionality” contacts are written, with one functionality being activated by the selection from the aggregated list displayed on the screen of the computer terminal, the corresponding “functionality” contact.

### BACKGROUND

1. Technical Field of the Invention

The present invention is related to a method for activating functionalities provided in a computer terminal. It is also concerned by a computer device and a computer terminal making it possible to implement such method. The invention relates to the general technical field of user assistance means or means for selecting functionalities facilitating the utilization of computer terminals.

2. State of the Art

Computer terminals (such as mobile telephones, portable or home computers, PDAs, BlackBerry® . . . ) are generally provided with a certain number of functionalities which make it possible for example to read mails (MAIL), to open an instant messaging session (IM), to communicate on a Blog (BLOG). Each of these functionalities is implemented by a specific (or software) computer application incorporated in the computer terminal.

FIG. 1 shows various types of screen images; of a computer terminal T upon the activation of such functionalities. Initially, the screen of the terminal T displays various functionalities (IM, MAIL, BLOG or any other one) in the form of bands, of icons or of drop-down menus. Using the navigation keys of his or her keyboard, the user can select the requested functionality.

For example, in case the user selects the instant messaging function (IM), a specific computer application (AIM®, ICQ®, Windows Live Messenger®, Yahoo!, Messenger® . . . ) is launched, so that the terminal T can connect to an instant messaging source server SIM (Microsoft Live Communication Server®, Sun Java System Instant Messaging®, Jabberd®, Groupwise Messenger® . . . ) and use the traditionally provided instant messaging services: conversation Svc1, contact list management Svc2, status management Svc3, etc. Such services Svc1, Svc2, Svc3 are displayed on the screen of the terminal T in the form of bands, icons or drop-down menus, etc. The user can then select the requested service using the keys on his or her keyboard. For example, when the user activates the conversation service Svc1, the server IM sends to the terminal T a list of “user” contacts U1, U2, U3, U4 (or “Budd, list”), said list being displayed on the screen of said terminal.

In case the user selects the mail function (MAIL), a new specific computer application (Google Mail®, SFR Mail®, Orange Mail®, Outlook®, . . . ) is launched, so that the terminal T can connect to a mail source server Smail (SendMail®, Zimbra®, Lotus®, Microsoft Exchange Server®, . . . ) and use the traditionally provided mail services: email reception/transmission Svc1, contacts management Svc2, message rules Svc3, etc. Such services are displayed on the screen of the terminal T in the similar way as for the IM function described hereabove. For example, when the user actuates the mail reception/transmission service Svc1, the MAIL server sends back to the terminal T the user mailbox, with the list of the mails being displayed on the screen of said terminal. It should be understood that a similar operation is implemented when the user selects the BLOG function or any other function.

The aim of the invention is to provide a new interface which will be easier to handle and make it possible for a user to activate the functionalities on a computer terminal. More particularly, the invention aims at integrating into a computer terminal, functionalities making it possible to have a quick access to some services, when a user previously subscribed to such services.

### SUMMARY

Therefore, the object of the invention is a method for activating functionalities provided in a computer terminal and delivered by source servers, with one of these functionalities being an instant messaging service in which a list including “user” contacts is displayed on the screen of said terminal, such method being remarkable in that:
an instant messaging server delivering the instant messaging service emits the list of the “user” contacts,
the list of the “user” contacts passes through a gateway server remote from the computer terminal,
the gateway server adds, on the fly, “functionality” contacts into the list of the “user” contacts,
the gateway server transmits to the computer terminal an aggregated list forming the single interface and including the “user” contacts as well as the “functionality” contacts,
the computer terminal displays on its screen the aggregated list in which the “user” contacts and the “functionality” contacts are written,
a functionality being activated by the selection from the aggregated list displayed on the screen of the computer terminal of the corresponding “functionality” contact.

Now, the user of the computer terminal has a unique interface which is similar to that used during the implementation of an instant messaging session and making it possible to very easily activate the various functionalities provided by said terminal. Such new interface thus created requests less resource than the interfaces known to the persons skilled in the art and traditionally provided to the users of computer terminals. For this reason, it is particularly advantageous to provide this new interface on the mobile terminal where the resources must be optimized.

For the generation of “functionality” contacts, the gateway server can directly generate said contacts. In this case, the gateway server includes a database in which each user of a computer terminal and the functionalities associated with the services which said users subscribed to are matched, said gateway server generating, for each user, the “functionality” contacts associated with said subscribed services. In an alternate embodiment, the source servers directly generate the “functionality” contacts. In this case, the source servers transmit to the gateway server the “functionality” contacts associated with the services which the user of the computer terminal subscribed to. In another alternate embodiment, the source servers transmit to the gateway server information indicating the services which the user of the computer terminal subscribed to, said gateway server generating the “functionality” contacts associated with said received information.

According to the preferred characteristics of the invention:
upon the displaying on the screen of the computer terminal, the “user” contacts are associated with presence statuses,
during the displaying on the screen of the computer terminal, all or part of the “functionality” contacts are associated with statuses containing information on the condition of the corresponding functionalities,
the various statuses are regularly updated.

### Advantageously:

the computer terminal transmits requests for updating to the source servers,
in response to such requests, the source servers transmit, to the computer terminal, information relating to the updating of the statuses associated with the “user” contacts and the “functionality” contacts.

The invention also relates to a device for activating functionalities provided in a computer terminal and delivered by source servers, one of the functionalities being an instant messaging service in which a list including “user” contacts is displayed on the screen of said terminal, such device being remarkable in that it includes:
an instant message server which the computer terminal connects to, said server including means for emitting the list of “user” contacts,
a gateway server remote from the computer terminal and which a list of “user” contacts passes through, said server including:
means for adding, on the fly, “functionality” contacts to the list of the “user” contacts,
means for transmitting to the computer terminal an aggregated list forming a unique interface and including the “user” contacts, as well as the functionalities contacts, so that said list is displayed on the screen of said terminal,
and remarkable in that a functionality is activated by the selection from the aggregated list displayed on the screen of the computer terminal of the corresponding “functionality” contact.

Still another aspect of the invention is related to a computer terminal and more particularly a mobile telephone provided with a screen and in which several functionalities are provided, with one of these functionalities being an instant message service in which a list including “user” contacts is displayed on said screen, said terminal being remarkable in that “functionality” contacts are added into the list of “user” contacts, so that an aggregated list in which said “user” contacts and said “functionality” contacts are written, is displayed on the screen, and in that one functionality is activated by the selection from the aggregated list of the corresponding “functionality” contact.

### BRIEF DESCRIPTION OF DRAWINGS

Other advantages and characteristics of the invention will become apparent upon reading the following description of a preferred embodiment and referring to the appended drawings provided as indicative and non limitative examples, wherein:

FIG. 1 illustrates several types of images of a screen of a prior art mobile terminal upon the activation of functionalities;

FIG. 2 is a diagram of the various steps of the method which is the object of the invention;

FIG. 3 is a chronological illustration of the various steps of the method which is the subject of the invention;

FIG. 4 shows a diagram of the communication network in which the computer terminal implements a MAIL session; and

FIG. 5 diagrammatically shows a communication network in which the computer terminal implements an instant messaging session IM.

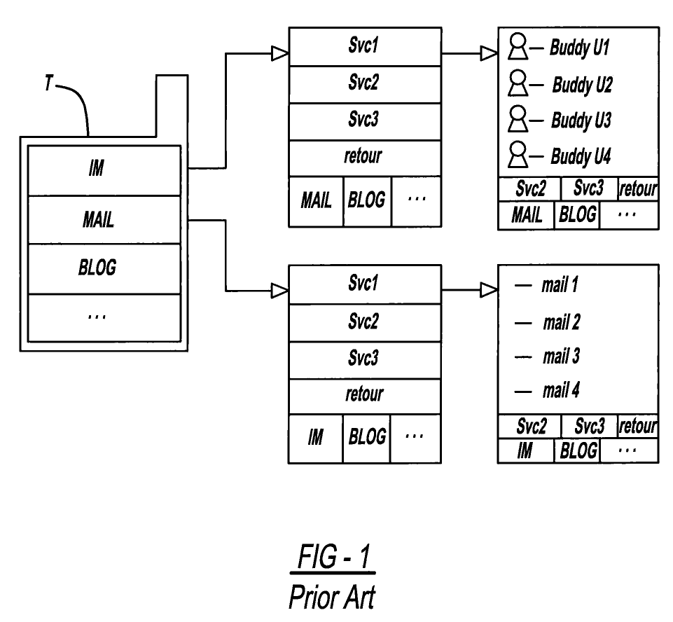

### DETAILED DESCRIPTION

The method which is the object of the invention makes it possible to activate functionalities provided in a computer terminal T and delivered by source servers SIM, Smail, SBlog, S . . . . It can more particularly be applied to the generation of an interface requiring little resource and making it possible to activate functionalities provided in a mobile telephone.

The computer terminal T used for the implementation of the invention can be a mobile terminal such as a mobile telephone, a device of the personal digital assistance type (PDA), a device of the BlackBerry® type or a stationary terminal such as a PC computer. The terminal T is provided with a screen. In a way known to the persons skilled in the art, the terminal T is provided with a processor configured for executing one or several programs, sub-programs, micro-programs or any other type of equivalent software in order to manage the steps of the method which will be described in detail in the following description. The terminal T also incorporates a certain number of computer applications (programs, sub-programs, micro-programs . . . ) make it possible to implement the various functionalities integrated therein: instant messaging, mails, blog, etc.

The source servers SIM, Smail, SBlog, S . . . are well known to the persons skilled in the art. They make it possible to deliver the functionalities provided in the computer terminal T. They generally consist of a computer or a computer program configured for providing functionalities (mails, blog) and more particularly the instant messaging services to a terminal T connected thereto. In practice, this is an instant messaging server S_{IM}: Microsoft Live Communication Server®, Sun Java System Instant Messaging®, Jabber®, Groupwise Messenger® or any other service; a mail server Sₘₐᵢₗ: SendMail®, Zimbra®, Lotus®, Microsoft Exchange Server® or any other service; a blog server S_{Blog} or any other similar server capable of delivering services. In a way known per se, the source servers S_{IM}, Sₘₐᵢₗ, S_{Blog}, S . . . integrate computer applications and are provided with a processor configured for running one or several programs, sub-programs, micro-programs or any other type of equivalent software enabling them to manage the various functionalities F1, F2, F3 which are provided in the terminal T, as well on the steps of the method which will be described in greater detail in the following description.

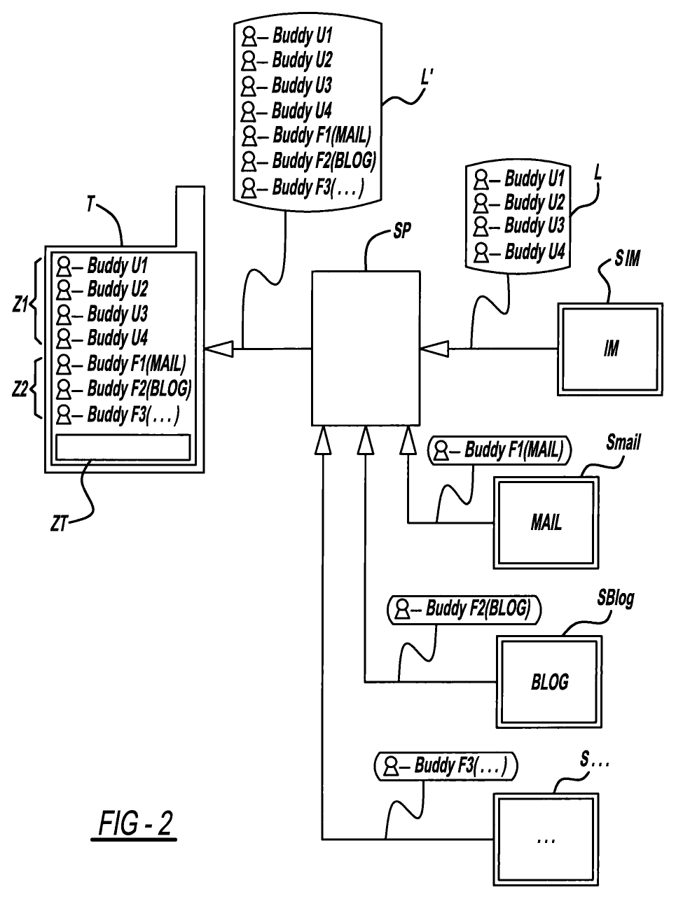

While referring to FIGS. 2 to 5, the terminal T is configured for displaying on its screen the various functionalities provided (MAIL, IM, BLOG or any other functionality) as contacts (or “Buddies” in the “user” contacts list of the instant messaging service thereof (or “Buddy list”). In practice, as soon as the user wishes to access the various provided functionalities (via the menu of his or her terminal T), the screen of the terminal T displays a list of contacts wherein are simultaneously present: the “user” contacts U1, U2, U3, U4 proper (screen area Z1) and the “functionality” contacts F1 for example a MAIL function, F2 for example a BLOG function, F3 another function (screen area Z2). This list of contacts is in HTML format or in any other format conventionally used in an instant messaging system. The user can activate one of these functionalities by selecting from the aggregated list displayed on the screen of the terminal T the corresponding “functionality” contact.

According to the invention and while referring to FIG. 2, “functionality” contacts F1(MAIL), F2(BLOG, F3( . . . ) are added, on the fly, in a server SP which is remote from terminal T, in the list L of the “user” contacts U1, U2, U3, U4. Then, an aggregated list L′ is transmitted to the terminal T which includes the “user” contacts U1, U2, U3, U4 and the “functionality” contacts F1, F2, F3 so that said aggregated list can be displayed on the screen of said terminal. The user of terminal T thus has at his or her disposal a unique interface which is similar to that used upon the implementation of an instant messaging session, but requiring less resources and making it possible to very easily activate the various functionalities provided by said terminal.

In practice, when the terminal T is connected to an instant messaging server S_{IM}, the latter emits a list L of “user” contacts. This initial list L groups the various persons U1, U2, U3, U4 (Buddies) with whom the user on the terminal T can communicate through the instant messaging services. This “user” contacts list L passes through a gateway server SP remote from the terminal T. This gateway server SP adds, on the fly, the “functionality” contacts F1, F2, F3 into the list L of the “user” contacts.

The gateway server SP is independent or not of the source servers S_{IM}, Sₘₐᵢₗ, S_{Blog}, S . . . . The gateway server SP is so arranged that all or part of the information intended to or emitted by the terminal T pass through said gateway server. In practice, this gateway server SP, well known to the persons skilled in the art, is a computer or a computer program configured to provide some services to the computer terminals of the clients which connect thereto. The gateway server SP can in particular be equipped with means making it possible to manage an instant messaging session, filtering messages, managing “user” contacts lists, etc. Other services such as: weather forecast, advertisements, games, audio messages or any other service can also be implemented by the gateway server SP. The latter makes it possible to remove and/or add some functionalities without having to modify the source server SS. In a well known manner, the gateway server SP incorporates computer applications and is provided with a processor configured to run one or several programs, sub-programs, micro-programs or any other type of equivalent software enabling it to manage the steps of the method which will be described in greater detail in the following description.

First case: the “functionality” contacts F1, F2, F3 are generated directly by the gateway server SP. In this case, the gateway server SP knows the functionalities which are liable to be provided in the terminal T and accordingly generates “functionality” contacts which are proper to each computer. As a matter of fact, the gateway server SP will generate the “functionality” contacts according to the user and the services which the latter subscribes to. The gateway server SP therefore includes a database in which the users and the functionalities liable to be provided on the computer terminal are matched. In practice, when the user activates his or her terminal T, the latter transmits a request for authentication to the gateway server SP. Once authentified, the gateway server SP analyses the services subscribed to by the user and generates the corresponding “functionality” contacts.

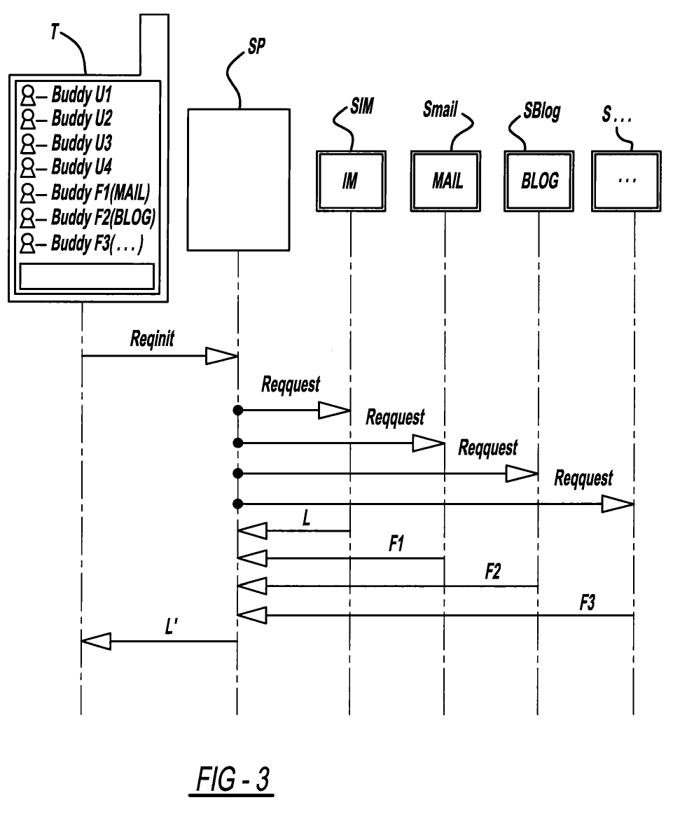

Second case: the “functionality” contacts F1, F2, F3 are directly generatedby the source servers Sₘₐᵢₗ, S_{Blog}, S . . . . This case is illustrated by FIGS. 2 and 3. When the user activates his or her terminal T, the latter emits a request for authentication Reqₐᵤₜₕ to the gateway server SP. Once the user is authentified, the gateway server SP interrogates the various !source servers Sₘₐᵢₗ, S_{Blog}, S . . . so as to know whether the user subscribed to various services they provide. In practice, the gateway server SP emits, to the various source servers, requests Req_{guest} therefor, said requests containing the user identification. Upon reception of such requests Req_{guest}, the various source servers S_{IM}, Sₘₐᵢₗ, S_{Blog}, S . . . check the user's identification. If the user's identification is acknowledged by the source service S_{IM}, Sₘₐᵢₗ, S_{Blog}, S . . . and the latter will transmit the corresponding contacts: the server IM S_{IM} will transmit the list L of the “user” contacts U1, U2, U3, U4 and the other servers Sₘₐᵢₗ, S_{Blog}, S . . . will transmit the “functionality” contacts F1, F2, F3 associated with the services they provide and which the user subscribed to. From now on, the gateway server SP will add “functionality” contacts F1, F2, F3 into the list L of the “user” contacts and will transmit the aggregated list L′ to the terminal T.

Third case: the “functionality” contacts F1, F2, F3 are generated by the gateway server SP and by the source servers Sₘₐᵢₗ, S_{Blog}, S . . . . It can be provided that after receiving the requests Req_{guest} and acknowledged the user identification, the various source servers Sₘₐᵢₗ, S_{Blog}, S . . . will transmit to the gateway server SP, not directly the “functionality” contacts F1, F2, F3 but rather information indicating to said gateway server the services which the user subscribed to. Then the gateway server SP will generate the “functionality” contacts F1, F2, F3 which are associated with the received information.

For activating one functionality, the user can directly select from the aggregated list L′ displayed on the screen of the terminal T, the corresponding “functionality” contact. The user can, for example using the navigation keys of his or her keyboard, select the required functionality and activate it with a simple click. In this case, the computer application associated with the activated functionality is conventionally launched with the interface usually associated with said functionality directly being displayed on the screen of the terminal T.

In an alternate embodiment, the user inscribes, in the text zone ZT of the terminal T, the name of the “functionality” contact associated with the functionality he or she wishes to activate. For example, he or she will enter the word “F1” or “MAIL” if he wishes to use the MAIL functionality or the word “F2” or “BLOG”, if he or she wishes to use the BLOG functionality etc. The MAIL or BLOG functionalities can be associated with numbers, symbols or more generally with predefined text messages. In this case, the user will enter in the text zone ZT the text message associated with the functionality he or she wishes to use. The text message written in the text zone ZT is then sent to the gateway server SP for example in an HTML format. To use the instant messaging system IM, the user just have to enter in the text zone ZT the name of the “user” contact or contacts U1, U2, U3, U4 whom he or she wishes to talk to.

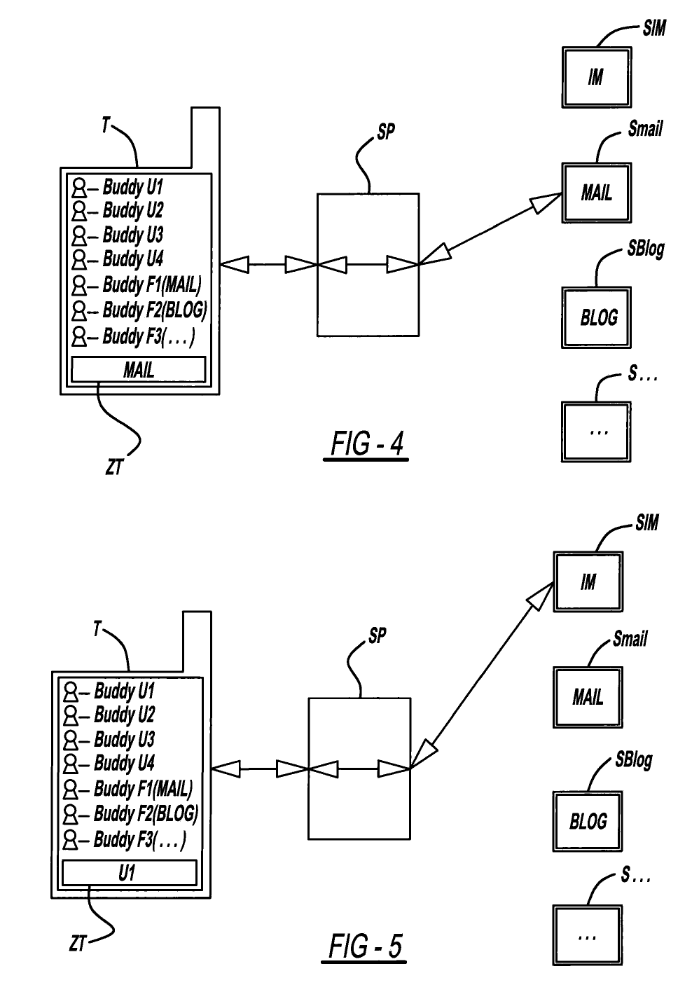

While referring to FIG. 4, in case the text message sent is “MAIL” (or a text message associated with the MAIL function for example “F1”), the gateway server SP is capable of “understanding” this message to establish the connection with the corresponding MAIL source server Sₘₐᵢₗ. A similar operation occurs when the text message sent corresponds to the BLOG function or any other function. To understand the text messages it receives, the gateway server SP advantageously includes a memory zone in which the text messages are associated with the requests intended to be sent to the source servers S_{IM}, Sₘₐᵢₗ, S_{Blog}, S . . . . For example, when it receives the text message (in the target format) associated with the MAIL function, the gateway server SP includes software which is capable of analyzing this text message and associating it with the request intended to the source server MAIL Sₘₐᵢₗ. While referring to FIG. 5, in case the text message sent corresponds to the “user” contact name U1, the gateway server SP includes this message to establish a connection with the corresponding source server S_{IM}: the gateway server SP analyses the text message U1 and associates it to the request intended to the source server S_{IM}. The requests sent by the gateway server SP to the source server S_{IM}, Sₘₐᵢₗ, S_{Blog}, S . . . is in practice a conventional request of authorization to connect making it possible to implement the services associated with the functionality chosen by the user.

Upon the display on the screen of the terminal T, the “user” contacts U1, U2, U3, U4 are preferably associated with regularly updated presence statuses. Such presence statuses can for example indicate that a user is available, not available, temporarily available, etc. The more or less complex updating of the “user” contacts presence statuses is for example described in documents of the patent US2003/073440 (VERSADA NETWORKS), US2004/056901 (MARCH), US2006/009243 (AT & T WIRELESS SERVICES), US2006/129643 (NIELSON), US2006/194596 (DENG), US2008/299953 (RAO) or US2008/267091 (NOKIA). In practice, the terminal T regularly transmits requests for updating operations to the instant messaging server S_{IM} (via the gateway server SP or not). In response to such requests, the instant messaging server S_{IM} transmits to the terminal T (via the gateway server SP or not) information upon the updating of the presence data associated with the “user” contacts.

According to an advantageous characteristic of the invention, upon the display on the screen of the terminal T or part of the “functionality” contacts F1, F2, F3 are also associated with the statuses containing information of the condition of the corresponding functionalities. For example, opposite the “functionality” contact F1 (MAIL), the number of unread messages, opposite the “functionality” contact F2(BLOG), the number of comments on the blog etc. As for the presence statuses, the various statuses are regularly updated. In practice, the terminal T regularly transmits requests for updating to the source servers SIM, S mail, SBlog, S . . . (via the gateway server SP or not). In response to such requests, the source server transmits to the terminal T (via the gateway server SP or not) information on the updating of the statuses associated with the corresponding “functionality” contacts.

1. A method for activating functionalities provided in a computer terminal and delivered by source servers with one of these functionalities being an instant messaging system where a list including “user” contacts, is displayed on the screen of said terminal, said method comprising:
an instant messaging server, delivering the instant messaging service, emitting the list of the “user” contacts;
the list of the “user” contacts passing through a gateway server remote from the computer terminal;
the gateway server adding on the fly, “functionality” contacts into the list of the “user” contacts;
the gateway server transmitting to the computer terminal an aggregated list forming a unique interface and including the “user” contacts as well as the “functionality” contacts;
a computer terminal displaying, on the screen thereof, the aggregated list wherein the “user” contacts and the “functionality” contacts are written; and
a functionality being activated by the selection from the aggregated list displayed on the screen of the computer terminal, the corresponding “functionality” contact.

2. A method according to claim 1, wherein the gateway server includes a database in which each user of a computer terminal and the functionalities associated with the services which said users subscribed to are matched, said gateway server generating for each user, the “functionality” contacts associated with said subscribed services.

3. A method according to claim 1, wherein the source servers transmit to the gateway server the “functionality” contacts associated with the services which the user of the computer terminal subscribed to.

4. A method according to claim 1, wherein the source servers transmit to the gateway server information indicating the services which the user of the computer terminal subscribed to, with said gateway server generating the “functionality” contacts associated with said received information.

5. A method according to claim 1 wherein:
upon the displaying on the screen of the computer terminal, the “user” contacts are associated with presence statuses;
upon the displaying on the screen of the computer terminal, all or part of the “functionality” contacts are associated with statuses containing information on the condition of the corresponding functionalities; and
the various statuses are regularly updated.

6. A method according to claim 5, wherein the computer terminal transmits requests for updating to source servers, in response to such requests the source servers transmit to the computer terminal information on the updating of the status associated with the “user” contacts and “functionality” contacts.

7. A device for activating the functionalities provided in a computer terminal and delivered by source servers, with one of these functionalities being an instant messaging service in which a list including “user” contacts is displayed on the screen of said terminal, the device comprising:
an instant messaging server which the computer terminal is connected to, said server includng and emitter operably emitting the list of the “user” contacts;
a gateway server remote from the computer terminal and through which the list of the “user” contacts passes through, said server including:
means for the server operably adding on the fly the “functionality” contacts into the list of the “user”;
the server operably transmitting to the computer terminal an aggregated list forming the unique interface and including the “user” contacts as well as the “functionality” contacts, so that said list is displayed on the screen of said terminal; and
one functionality is activated by the selection from the aggregated list displayed on the screen of the computer terminal, the corresponding “functionality” contact.

8. A computer terminal comprising a screen and several functionalities, with one of these functionalities being an instant messaging service in which a list including “user” contacts is displayed on said screen;
wherein “functionality” contacts are added into the list of the “user” contacts, so that an aggregated list in which said “user” contacts and said “functionality” contacts are written, is displayed on the screen; and
wherein and in that one functionality is activated by the selection from the aggregated list of the corresponding “functionality” contact.

9. A computer terminal according to claim 8, further comprising said terminal being a mobile telephone.
